(19) United States
(12) Patent Application Publication
(10) Pub. No.: US 2014/0138263 A1
(43) Pub. Date: May 22, 2014

(54) Artist's Palette Accessory and Paint Storage System

(71) Applicant: Patricia Ann Kellner, Redondo Beach, CA (US)

(72) Inventor: Patricia Ann Kellner, Redondo Beach, CA (US)

(21) Appl. No.: 14/084,599

(22) Filed: Nov. 19, 2013

Related U.S. Application Data
(60) Provisional application No. 61/796,896, filed on Nov. 20, 2012.

(51) Int. Cl. B44D 3/00

(52) U.S. Cl. CPC B44D 3/00
USPC 206/1.7

(57) ABSTRACT

This palette accessory and paint storage system keeps oil paint fresh and pliable for weeks at room temperature. A linear paint tray, upon which daubs of paint are placed, is stored inside an air tight tube. Felt wicks mounted inside the end caps hold clove oil, which prevents the oxidation of oil paints. For heavy bodied acrylics, the end caps are mounted with sponge material or silica gel that would be moistened to create a humid environment that prevents acrylics from drying and hardening.

When the artist is ready to paint, the paint tray is removed from the storage tube and secured with clips or Velcro to a mixing palette, paint box, or easel. The painter dips into the paint daubs on the tray to mix the desired colors on their palette. When done painting, the paint tray, with the unused paint, is re-inserted into the tube for storage and transport.

### CROSS REFERENCE TO RELATED APPLICATIONS

This application claims the benefit of U.S. provisional application No., 61/796,896 entitled “Artist's Palette and Storage System”, filed on Nov. 20, 2012, and herby incorporates that application in its entirety.

### BACKGROUND OF THE INVENTION

Oil and acrylic painting, both in studio and outdoors, is becoming a very popular pastime. One of the less appealing tasks involved with painting is that of setting up your palette with the desired colors of oil or acrylic paint and the cleanup once one is finished with a painting session. Artists place a line of fresh paint daubs squeezed from paint tubes along the edge of their palette, paint box, or easel box. They then pick up paint from the daubs to mix together on the palette surface to form the desired colors. Paint is expensive, and artists try and anticipate how much paint they will need of each color. Because acrylic paint dries out within a few hours of leaving the tube, and oil paint hardens through oxidation after a day or so outside the paint tube, artists frequently have to either throw away the paint that remains at the end of a painting session, or try and preserve it for a day or two. Some paint storage systems require that the paint be transferred with a palette knife from the palette into the paint storage container that then must be placed in the freezer if paint is to be saved for more than a couple of days. A lot of paint is lost in the process of moving the paint daubs from one location to another.

### BRIEF SUMMARY OF THE INVENTION

This palette accessory consists of a paint tray, on which the artist places daubs of paint squeezed from a paint tube. This paint tray is then attached to a traditional palette or paint box, conveniently keeping the daubs of paint separate from the mixing surface. Using a palette knife or brush, the artist grabs bits of paint from the daubs, as needed, to mix desired colors on the palette surface. After the artist is done painting, the paint tray, with all remaining daubs of oil or acrylic paints, slides easily and cleanly inside the air tight storage tube and the end caps are placed on the ends of the tube. The remaining paint daubs are now ready for transport and will be prevented from oxidizing, skinning over, or drying out by the substance contained within the end caps.

Each end cap contains a felted wool wick that can be moistened with an anti-skinning, anti-oxidizing agent, such as clove oil (clove leaf oil, clove bud oil, or clove stem oil). Eugenol, which is the volatile component of the clove oil, will slowly evaporate from the wick and keep the daubs of oil paints fresh for weeks at room temperature.

The felt wicks are mounted in the center of the end caps, in a location to the side of and above the daubs of oil paint on the tray. This prevents the clove oil itself from touching the paint. This is important, as paint mixed with clove oil changes the characteristics of the oil paint in a way that is not desirable to most painters. Instead, only the volatile component of the clove oil, eugenol, evaporates into the air space of the storage tube and thus affects only the outermost layer of the paint daubs, preventing the paint from forming a skin and hardening through oxidation.

Likewise, acrylic paints, which “dry out” instead of oxidizing, can be kept moist by adding water to silica gel pillows or sponges mounted inside the end caps instead of the felt wicks. This moistened sponge or gel maintains a humid environment for daubs of heavy body acrylic paints that have a consistency similar to oil paints.

This system allows the artist to stop work on a painting for several days or weeks and return to the same selection of paints that were on the paint tray when the painting session ended.

This palette accessory and paint storage system improves the painting experience, allowing the artist to save time (no need to squeeze out all new fresh paint) and money (no need to discard good paint at the end of a painting session). The paint tray containing the daubs of paint is clipped or attached using Velcro to a paint box or mixing palette, or easel surface. Because any excess paint can be preserved for weeks, the painter is free to place more generous amounts of paint on the paint tray—enough for several paintings, and thus eliminate the interruption of having to squeeze more paint out during a painting session. When necessary, the artist can add new paint to supplement the older paint on the paint tray before a painting session begins. When the artist paints outdoors, it is no longer necessary to bring along all the heavy tubes of paint colors as sufficient paint can be placed on the paint tray ahead of time. Also, while spending several days painting in the field, there is no need to store oil paints in a freezer as the eugenol in the clove oil prevents oxidation at room temperature.

Once finished with a painting session, the paint tray containing the remaining paint is easily moved as a single unit and placed inside the storage tube until the next painting session—perhaps weeks later. This system has an additional benefit of keeping both the artist's clothing and supplies cleaner and free from errant daubs of paint. The combined system of storage tube, paint tray and end caps make for an efficient and compact manner of storing and transporting paint that has been removed from a paint tube.

### BRIEF DESCRIPTION OF THE SEVERAL VIEWS OF THE DRAWING

FIG. 1 is a perspective view of the the elongated storage tube, which is cylindrical in the preferred embodiment.

FIG. 2 is a perspective view of the elongated paint tray on which daubs of paint are placed. This paint tray is designed to fit inside the tube illustrated in FIG. 1.

FIG. 3 is a perspective view of one end cap onto which has been mounted a wool felt wick. An end cap would be placed on either end of the tube in FIG. 1, making it airtight.

FIG. 4 is a perspective view showing the paint tray partially inserted into the tube. One end cap has been placed on the left hand end of the tube, but the end cap for the other end of the tube is not shown.

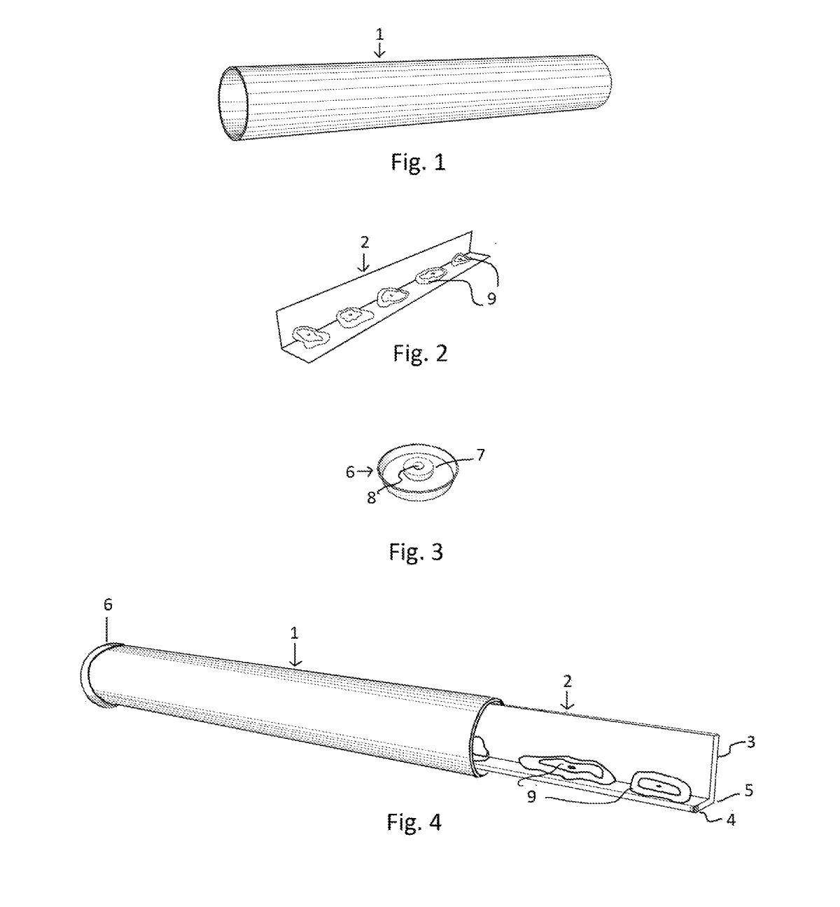

### DETAILED DESCRIPTION OF THE INVENTION

1. Storage tube

2. Paint tray

3. Vertical surface of paint tray

4. Horizontal surface of paint tray

5. Vertex of surfaces 3 and 4

6. End cap

7. Felt wick

8. Chicago binding screw cap

9. Paint daubs

This palette accessory and paint storage system consists of a clear plastic storage tube 2, a plastic paint tray 2, and two end caps 6, which have been fitted with round wool felt wicks 7¾″ diameter, and ¼″ deep. The felt wick 7 is attached to the end cap 6 using a Chicago binding screw 8 or other fastener.

The paint tray has two surfaces 3 and 4 that intersect at a vertex 5. In the preferred embodiment the two surfaces 3 and 4 form a right triangle, the hypotenuse of which is slightly less in length than the diameter of the tube. In the preferred embodiment shown here, the tube has an inner diameter of 1.65 inches and each the surface 3 and 4 of the paint tray is 1.125″ wide, although other sizes that allow the hypotenuse to be smaller than the tube diameter would work. This configuration allows the paint tray to rotate easily within the tube while minimizing the volume of air space. Daubs of paint 9 are squeezed out of paint tubes and deposited onto the paint tray 2 in the vertex 5 of the triangle made by the surfaces 3 and 4. Because the vertex, filled with the paint daubs, is the heaviest portion of the paint tray, the paint daubs 9 always come to rest in an upright position even if the tube is rotated along a horizontal axis. This prevents the paint from contacting the surface of the tube.

In the preferred embodiment, the end caps 6, provide an airtight, friction fit on the outside of the tube, although alternative embodiments could employ end caps that screw on, have a gasket and clip system, or some other closure system. End caps that fit over the perimeter of the tube, sometimes called plugs, could also be used. Likewise, although a clear plastic tube 1 is used in this embodiment, an appropriately sized tube of any non-porous material would work. The tube in the preferred embodiment is cylindrical, but another shape including, but not limited to square or triangular could be used in an alternative embodiment. In the preferred embodiment the tube 1 is open at both ends, requiring two end caps. In an alternative embodiment, it could be closed on one end and only require one end cap.

Wool felt wicks 7 are attached to the inside of each end cap 6 to act as a clove oil reservoir. Clove oil will release the volatile component eugenol into the air space of the closed tube. Eugenol acts is an anti-oxidant that prevents the outer-most molecular layer of the oil paint from oxidizing and forming a hardened skin. The presence of eugenol results in an anti-skinning action, allowing the oil paint to remain soft and pliable for weeks at room temperature. Without the eugenol, the oil paint would begin to form a skin within 24 hours and become completely hardened in a few days. Because clove oil, if mixed directly with the paint, will prevent a painting from drying for months, it is desirable to only expose the surface of the oil paint daubs to the eugenol evaporate, not to the oil itself. If, instead, the clove oil made liquid contact with the paint it would change its character and drying time. Thus the wicks suspend the oil away from the paint while allowing for the release of the anti-oxidant eugenol. The artist's hands are protected from touching the clove oil as the wick is shrouded within the plastic end cap. Clove oil can be applied directly from the bottle to the wick, again, without having to contact clove oil.

The felt wicks 7 are attached to the end caps using a fastener such as a Chicago binding screw, pop rivet, grommet, or other mechanical fastener. This was necessary because the eugenol in the clove oil dissolves all forms of adhesive.

An alternative embodiment of this paint storage system is for use with acrylic paints, instead of oil paints, would use sponges or gel caps or sponges inside the end caps. Acrylic paints “dry out” instead of oxidizing, but if they are kept in a sufficiently humid environment, they can remain pliable and ready to use. The acrylic paints could be kept moist by adding water to gel pillows secured inside the end caps. The gel would contain a potassium-based cross-linked polymer, or other humectant. An even simpler method would be to or add water to a sponge secured inside the end caps. Either approach would then maintain a humid environment and prevent acrylic paints from drying and hardening.

While the principles of this invention have been specified in the above paragraphs, other arrangements of size and proportion, materials used, and other departures from this preferred embodiment would come to mind by anyone of ordinary skill in the field of painting. Thus the following claims are intended to include any such modifications within the true spirit and scope of the invention.

A palette accessory for using for storing artists paints in a manner to prevent oxidation of oil paints comprising:

1. An elongated tube with sized to receive an elongated paint tray.

2. The tube of claim 1 with two open ends

3. The tube of claim 1 with one open end and one closed end.

4. An elongated paint tray consisting of two planar surfaces that meet at a vertex sized to fit and rotate within the tube described in claim 1.

5. The tray in claim 4 can receive daubs of paint in the vertex.

6. Tube of claim 1 and paint tray of claim 2 are sized and weighted so that when rotated on a horizontal axis, the paint daubs on the paint tray will always come to rest facing upward within the tube and therefore the paint will not touch the walls of the tube during transport.

7. End caps fit on the open ends of the tube in claim 1 to create an air tight seal.

8. End caps of claim 7 fit over the outside of the open end(s) of the tube through a friction fit, screw-on fit, pressure gasket or other type of fit.

9. End caps of claim 7 fit inside the open end(s) of the tube through a friction fit, screw-on fit, pressure gasket or other type of fit. In this case they may be referred to as plugs, not caps.

10. End caps of claim 7 contain a felted wool wick that can act a reservoir for clove oil or other anti-oxidant which has been mounted inside the end cap using a fastener: A Chicago binding screw; grommet; or pop rivet.

11. End caps of claim 7 contain a wick that can act a reservoir for clove oil or other anti-oxidant which has been mounted inside the end cap using a fastener: A Chicago binding screw; grommet; or pop rivet.

12. The felted wick of claim 10 holds the clove oil or other antioxidant suspended above and to the side of the oil paint daubs, inside the end cap, thus preventing the clove oil from having direct contact with the paint as only the evaporate of the volatile component of the clove oil, eugenol, contacts the outermost molecular layer of the oil paint, thus preventing oxidation.

13. The felt wick is mounted in such a manner that it remains shrouded within the inside of the end cap so as to allow clove oil to be applied directly from the bottle to the wick without the artist's hands having to touch the oil.

14. The storage tube of claim 1, with end caps of claim 7 and the paint tray of claim 4 are used in conjunction with sponge material or super absorbent polymers or silica gel packets mounted in the end caps for the purpose of creating an environment humid enough to prevent heavy body acrylic paints from drying out through evaporation.
